(19) United States
(12) Patent Application Publication
(10) Pub. No.: US 2009/0165389 A1
(43) Pub. Date: Jul. 2, 2009

(54) Window Lock and Method of Use

(75) Inventor: Joseph Kuppler, Somerdale, NJ (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: ULTRA HARDWARE PRODUCTS, LLC, Pennsauken, NJ (US)

(21) Appl. No.: 11/964,771

(22) Filed: Dec. 27, 2007

(51) Int. Cl. E05B 65/08

(52) U.S. Cl. 49/449

(57) ABSTRACT

A positive action window lock for automatically locking a window in a closed position. The window includes a first segment and a second segment. The window lock includes a base mounted to the first segment, a slider movably mounted to the base and an engagement portion mounted to the second segment. The slider is moveable to and between release and locking positions. The slider is in engagement with the engagement portion when the first and second segments are in the closed position to generally prevent movement of the first segment relative to the second segment or to lock the window in the closed position.

### BACKGROUND OF THE INVENTION

Window locks are well known for providing security for windows, wherein users are able to slide a first and/or second portion of a window to and between closed and open positions or to and between mounted and cleaning positions. Conventional window locks include a pivotable portion mounted to one of the windows and a receiving portion mounted to the complementary portion. In order to close and lock the window, the window portions are positioned in a closed position and the lock or locking portions are pivoted into a locked position beneath a receiving portion. The conventional locks typically require active operation or pivoting of the locking portion by a user after the window portions are moved to the closed position. In addition, window locks have typically been considered unsightly and are not readably adaptable to modification of their ornamental appearance, at least in part due to their functional construction, having sharp and uneven surfaces. It would be desirable to develop a window lock that automatically locks when the window is positioned in the closed position and has a desirable ornamental appearance that is adaptable by a user.

### BRIEF DESCRIPTION OF THE SEVERAL VIEWS OF THE DRAWINGS

The following summary, as well as the following detailed description of a preferred embodiment of the invention will be better understood when read in conjunction with the appended drawings. For the purpose of illustrating the invention, there is shown in the drawings, an embodiment which is presently preferred. It should be understood, however, that the invention is not limited to the precise arrangements and instrumentalities shown. In the drawings:

FIG. 1 is a front perspective view of a window lock mounted to a window in a closed position in accordance with a preferred embodiment of the present invention;

FIG. 2 is a magnified, fragmentary view of the window lock shown in FIG. 1 taken from within circle A of FIG. 1;

FIG. 3 is a top perspective view of the window lock shown in FIG. 1;

FIG. 4 is a top plan view of the window lock shown in FIG. 1;

FIG. 5 is a right-side elevational view of the window lock shown in FIG. 1;

FIG. 6 is a top perspective view of a base/mounting assembly of the window lock shown in FIG. 1;

FIG. 7 is a top perspective view of a snap-on cover of the window lock shown in FIG. 1; and

FIG. 8 is a keeper of the window lock shown in FIG. 1.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric sensor of the window lock and designated parts thereof. The terminology includes the words specifically mentioned, derivatives thereof and words of similar import. Additionally, the word “a” as used in this specification means “at least one”.

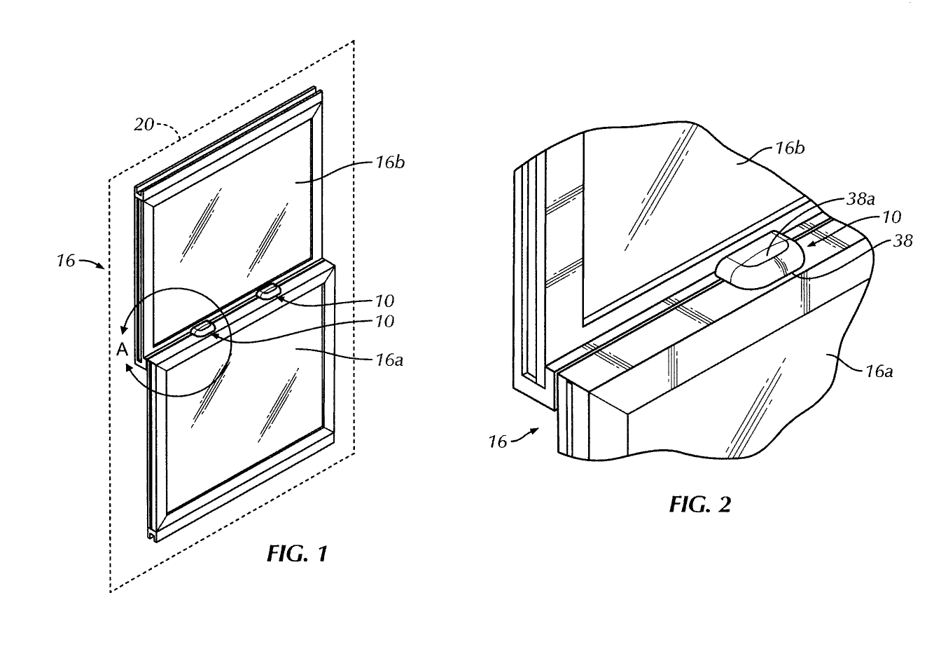

Referring to the drawings in detail, wherein like numerals indicate like elements throughout, there is shown in FIGS. 1-8, a preferred embodiment of a window lock, generally designated 10, of the present application. Referring to FIGS. 1-8, the window lock 10 includes a base 12, a slider 14 movable mounted to the base 12 and an engagement portion or keeper 18 that is in releasable engagement with at least a portion of the slider 14 to selectively lock and release a window 16.

In the preferred embodiment, the window lock 10 is mounted to a window 16 having first and second segments 16a, 16b that are movable relative to each other and at least one of which is movable relative to a window frame 20. In a closed position of the window 16, the window lock 10 is arranged to lock the window 16 and generally prevent movement of the first and second segments 16a, 16b relative to each other and the frame 20 or opening of the window 16. The window lock 10 is preferably accessible to a user from an inside of a structure, as would be apparent to one having ordinary skill in the art.

In the preferred embodiment, the base 12 is secured to a top edge of the first segment 16a and the engagement portion or keeper 18 is mounted to a lower portion of the second segment 16b. The base 12 and keeper 18 are preferably fastened, screwed or bolted to the first and second segments 16a, 16b to limit movement of the base 12 and keeper 18 relative to the first and second segments 16a, 16b. The base 12 and keeper 18 are preferably mounted to the first and second segments 16a, 16b by screws (not shown) to generally prevent the base 12 and/or the keeper 18 from being pried or forced off of the first or second segments 16a, 16b by an intruder attempting to thwart the window lock 10 from outside the structure. However, the base 12 and keeper 18 are not limited to being mounted by screws to the first and second segments 16a, 16b and may be otherwise mounted to the window 16 or may be mounted to one of the first or second segments 16a, 16b and/or the window frame 20, as long as the base 12 and keeper 18 align in the closed position to lock the window 16 relative to the frame 20, as will be described in greater detail below. Further, the base 12 and keeper 18 may be formed integrally with the first and second segments 16a, 16b such that there is not need for screwing or otherwise mounting the base 12 and keeper 18 to the first and second segments 16a, 16b. Specifically, the keeper 18 may be configured similar to an existing “sweep lock”, which is a configuration that would be understood by one having ordinary skill in the art.

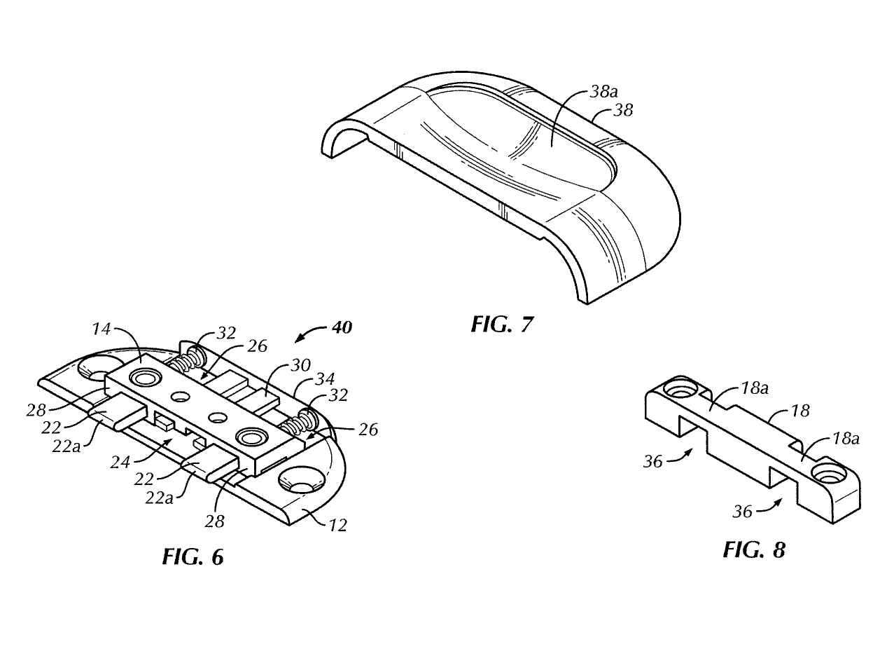

Referring to FIG. 6, the slider 14 has a generally rectangular-shape and includes a lock protrusion 22 and a keyway 24. The slider 14 is slidably mounted in a groove 26 on the base having a stop edge 28 proximate a forward end. The base 12 also preferably includes a guide rod 30 that cooperates with the keyway 24 to guide the sliding movement of the slider 14 along the groove 26. Accordingly, the sliding movement of the slider 14 is guided by the groove 26, the keyway 24 and the guide rod 30, but is not so limited. The sliding movement of the slider 14 may be guided by nearly any arrangement that permits the slider 14 to slide to and between locked and released positions relative to the base 12 and keeper 18.

The slider 14 is preferably biased toward the locking position by a pair of springs 32 that apply a force between the slider 14 and a vertical wall 34 of the base 12. Accordingly, the slider 14 is biased toward the locking position where a front face of the slider 14 buts against the stop edge 28. A force preferably must be applied to the slider 14 to move the slider 14 and the lock protrusions 22 from the locking position toward the release position against the bias of the spring 32. The slider 14 is not limited to being biased toward the locking position by the coil springs 32 and may be comprised of a material that has a natural spring-like property or may be otherwise biased towards the locking position, as would be apparent to one having ordinary skill in the art. The base 12, slider 14 and springs 32 comprise a base/mounting assembly 40.

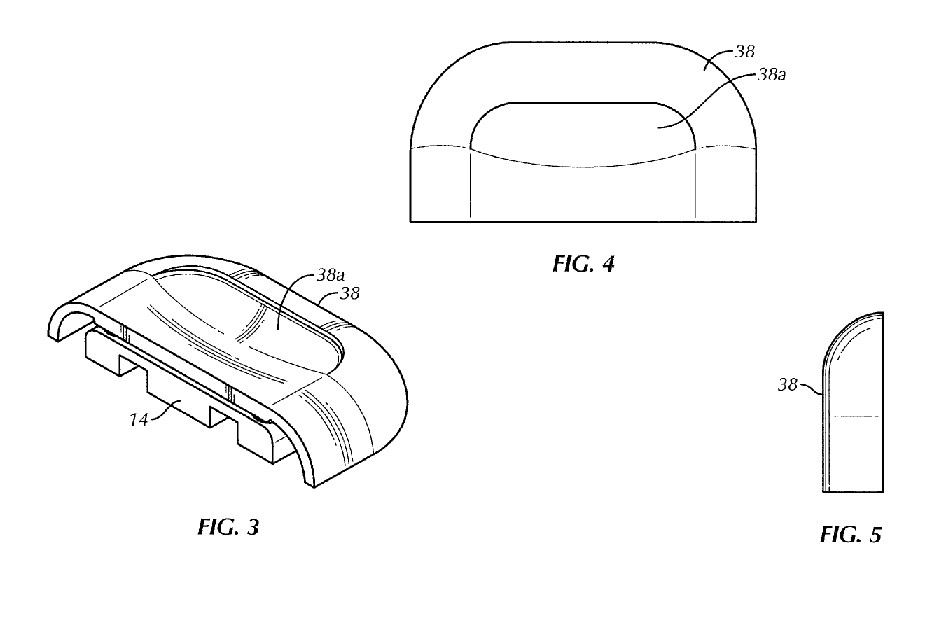

Referring to FIGS. 3, 6 and 8, in the preferred embodiment, the lock protrusions 22 of the slider 14 include a chamfered edge 22a at an end opposite the body of the slider 14 that faces downwardly or toward the keeper 18 in an assembled and mounted configuration. The chamfered edge 22a permits the slider 14 to slide from the locking position toward the release position when the first segment 16a is moved to the closed position relative to the second segment 16b through contact with a front edge 18a of the keeper 18. Specifically, as the first segment 16a slides to the closed position, the chamfered edge 22a engages the front edge 18a of the keeper 18 urging the slider 14 from the locking position towards the release position to permit the first segment 16a to move to the closed position. In the closed position, a top edge of the lock protrusions 22 clear the front edge 18a and the springs 32 urge the lock protrusions 22 into lock channels 36 in the keeper 18 and the body of the slider 14 into the stop edge 28.

In the preferred embodiment, the slider 14 is constructed of a polymeric material but is not so limited and may be constructed of nearly any generally rigid, structural material that is able to take on the general size and shape of the slider 14 and withstand the normal operating conditions of the slider 14. The polymeric material is preferred for the slider 14 due to its durability, relative ease of manufacturability and adaptability. However, the slider 14 may also be constructed of a metallic, composite or alternative generally rigid structural material. In addition, the base 12 is preferably constructed of a polymeric or composite material. However, the base 12 is not limited to being constructed of these listed materials and may be constructed of nearly any material, such as a zinc or aluminum alloy or other similar material that is able to take on the general size and shape of the base 12 and withstand the normal operating conditions of the base 12. For example, the base 12 may be formed integrally with the first segment 16a of the window 16, may be constructed of a composite material or nearly any material that is adaptable for construction of the base 12.

Referring to FIGS. 1-5 and 7, the window lock 10 also includes a cover 38 that is preferably snap locked onto the slider 14 to cover the slider 14, keeper 18 and base 12 in an assembled and closed configuration (FIGS. 1 and 2). The cover 38 preferably has a generally smooth, continuous and user desirable ornamental appearance that provides an overall attractive appearance for the window lock 10 in the assembled configuration. The external surface of the cover 38 is not limited to having the generally smooth, continuous, attractive ornamental appearance and may take on nearly any size and shape that is able to be mounted to the slider 14 and generally cover the slider 14, keeper 18 and base 12 in the assembled and closed configuration. However, the cover 38 preferably has the generally smooth, continuous, attractive external surface appearance to provide a generally attractive appearance to the window lock 10 and window 16 in the assembled and closed configuration.

The cover 38 is preferably constructed of a zinc or aluminum alloy and may be powder coated or have a plated finish on the external surface to enhance the ornamental appearance. The cover 38 is not limited to constructions utilizing zinc or aluminum alloys or powder coated and/or plated finishes and may be constructed of nearly any material such as a polymeric or composite material and have nearly any surface finish as long as the cover 38 is able to withstand the normal operating conditions and take on the general shape of the cover 38.

The cover 38 also preferably includes a grasping depression 38a in a top surface thereof that permits a user to grasp the cover 38 in the grasping depression 38a to slide the cover 38 and slider 14 relative to the base 12 against the bias force of the springs 32. The cover 38 is not limited to inclusion of the grasping depression 38a having the shape shown in the attached drawings and may have nearly any size or shape or may not be included in the top surface without significantly impacting the operation of the window lock 10. For example, a user may grasp the sides of the cover 38 to apply a force and move the cover 38 and slider 14 from the locking to the release position and separate grasping divots 38a may be located in sides of the cover 38 to accommodate application of this force. Further, the cover 38 may include a protrusion nearly anywhere on its surface that is engageable by a user's fingers to accommodate application of the force to move the cover 38 and slider 14 from the locking position to the release position.

The window lock 10 of the preferred embodiment may also include a second or several additional covers (not shown) that have a different ornamental appearance than the cover 38 shown in FIGS. 1-5 and 7. Accordingly, the cover 38 may be removed from the slider 14 and replaced with the second cover or nearly any number of alternative covers to change the overall ornamental appearance of the window lock 10. The interchangeable snap-on covers 38 permit the window lock 10 to be adaptable to various ornamental appearances that may be desirable for the user. For example, the appearance of the window lock 10 may be desirable to modify if a user modifies the décor of a room or simply desires a change in the appearance of the window lock 10. The multiple alternative covers (not shown) may provide an unlimited number of variable ornamental appearances, as would be apparent to one having ordinary skill in the art.

Referring to FIGS. 1-8, in operation, the keeper 18 is mounted to the second segment 16b, and the base/mounting assembly (FIG. 6) is mounted to the first segment 16a as is shown in FIGS. 1 and 2. One of the covers 38 is then selected based upon the desired ornamental appearance of the user and the cover 38 is preferably snap-locked onto the slider 14 to generally cover the base 12, slider 14 and keeper 18 in the locking and closed positions. In this assembled and closed position, the window lock 10 has a generally low-profile and pleasant ornamental appearance to the user. From the closed and locking position, the user grasps the cover 38 at the grasping depression 38a and slides the cover 38 and slider 14 from the locking position to the release position. In the released position, the lock protrusions 22 clear or move out of the lock channels 36 and the first segment 16a may be moved relative to the second segment 16b from the closed position to an open position. To close and lock the window, the first segment 16a is simply moved to the closed position wherein the chamfered edge 22a urges the slider 14 from the locking position to the release position just before the first segment 16a moves into the closed position and, in the closed position, the springs 32 bias the slider 14 to the locking position and the lock protrusion 22 automatically slides into the lock channels 36 to lock the window 16. Accordingly, a user does not have to actively manipulate the window lock 10 to lock the window 16 other than moving the first and second segments 16a, 16b into the closed position.

The window lock 10 is generally considered a positive action lock (PAL) or a sash lock that is constantly trying to close itself and results in the window 16 always being locked when the first and second segments 16a, 16b are in the closed position, unless a user is actively urging the cover 38 and slider 14 to the release position against the bias of the springs 32. The consumer/end user generally does not need to be concerned about whether the window lock 10 is locked, nor is an extra step required to lock/secure the window 16 since the window lock 10 engages the keeper 18 automatically when the window 16 is closed.

The window lock 10 has a relatively low profile when compared to conventional window locks. Specifically, the distance that an upper surface of the cover 38 is spaced from a top edge of the first segment 16a is small in comparison to conventional window locks.

The cover 38 has an ergonomic design that minimizes sight lines as well as curves and smooth lines that create a visually appealing look for the window lock 10 when mounted to the window 16. This visually appealing look is desirable to a user when compared to the rough, sharp-edged appearance of conventional window locks. Further, the cover 38 having the smooth, continuous surface that covers the base/mounting assembly 40 and the keeper 18 generally limits accumulation of dust and/or dirt from collecting on surfaces of these components and the external surface of the cover 38 is typically easier to clean when compared to the external surface of the sharp-edged and deeply devoted conventional window locks.

The base 12 and slider 14 may be constructed of a composite material and the cover 38 and keeper 18 may be constructed of an aluminum material, which allows the window lock 10 to maintain a stable and relatively low cost while providing a look and feel of metal, which is desirable to certain users or consumers.

The window lock 10 generally combines the function of a tilt window or latch and the security of a sash lock. The window lock 10 has a generally simple design for ease of assembly during manufacture and conceals mounting screws, as is shown in FIGS. 1 and 2, in the assembled configuration. The window lock 10 also protects the mounting screws from external scratching or other forces that could potentially damage the screws.

The window lock 10 of the preferred embodiment also includes interchangeable, snap-on covers 38 and the covers 38 may be powder coated or plated to enhance the ornamental appearance of the window lock 10.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention.

I/We claim:

1. A positive action window lock for automatically locking a window in a closed position, wherein the window has a first segment and a second segment, the window lock comprising:
a base mounted to the first segment;
a slider movably mounted to the base, the slider movable to and between a release position and a locking position; and
an engagement portion mounted to the second segment, the slider in engagement with the engagement portion when the first and second segments are in the closed position to generally prevent movement of the first segment relative to the second segment.

2. The window lock of claim 1 further comprising:
a first cover secured to the slider, the cover having a generally smooth, continuous exposed surface.

3. The window lock of claim 2 further comprising:
a second cover having a different appearance on at least its exposed surface in comparison to the exposed surface of the first cover, the first and second covers being removably mountable to the slider.

4. The window lock of claim 2 wherein the first cover is removably mounted to the slider.

5. The window lock of claim 1 wherein the slider is slidably mounted to the base and is biased toward the locking position by a spring.

6. The window lock of claim 2 wherein the first cover includes a grasping depression on a top surface, the grasping depression permitting a user to grasp and slide the first cover and slider relative to the base against the force of a biasing spring from the locking position to the release position.
